(19) United States
(12) Patent Application Publication
(10) Pub. No.: US 2003/0074780 A1
(43) Pub. Date: Apr. 24, 2003

(54) Three-dimensional elastomeric connector

(75) Inventors: Robert Doran, Apex, NC (US); Shawn M. Stephenson, Raleigh, NC (US)

Correspondence Address: David Bennett, Coats & Bennett, 1400 Crescent Green, Suite 300, Cary, NC, 27511, US

(73) Assignee: Ericsson Inc.

(21) Appl. No.: 09/859,180

(22) Filed: May 16, 2001

(51) Int. Cl. H01R 4/58

(52) U.S. Cl. 29/600

(57) ABSTRACT

A mobile terminal employs existing geometry such as a rear housing or shield box to carry a radiating element. This element is made of a flexible elastomer with a conductive filler. The element is applied by dispensing using a syringe type operation, where it would be squirted on the geometry or the part placed in a secondary injection mold tool. This tool would have the pattern as open volume in the steel that would allow the conductive elastomer to fill out the pattern and adhere to the part. The radiating element is flexible and conforming, simplifying the design by reducing additional carrying components, simplifying the tolerance chain and makes full use of the surface area.

### BACKGROUND OF THE INVENTION

The present invention relates to conductive features of mobile terminal, and more particularly conductive connections and antennas.

Mobile terminals often contain several separate components that must be electrically coupled. Traditionally the electric coupling of the several components is accomplished using wire runs having individual connectors for each coupled component. Alternately, the wire runs may be connected to the individual components using solder connections. Either of these methods of connection require several additional pieces that must be assembled, which assembly may not be automatable. These connections and attendant assembly steps result in an increase in the overall production cost of mobile terminals.

### BRIEF SUMMARY OF THE INVENTION

The invention herein employs the use of conductive elastomer features in a mobile terminal. Consistent with the present invention, the conductive elastomer features may be used to effect an electrical connection between components in a mobile terminal. Additionally, consistent with the present invention, a conductive elastomer may be configured as an antenna for a mobile terminal, wherein the antenna may be at least partially contained within the housing of the mobile terminal.

### BRIEF DESCRIPTION OF THE DRAWINGS

Advantages of the present invention will be apparent from the following detailed description of exemplary embodiments thereof, which description should be considered in conjunction with the accompanying drawings, in which like numerals depict like parts, and wherein:

FIG. 1 is a perspective view of a first exemplary embodiment consistent with the present invention;

FIG. 2 is an exploded perspective drawing of detail II of FIG. 1;

FIG. 3 is an exploded perspective drawing of detail III of FIG. 1;

FIG. 4 is a perspective view of a second exemplary embodiment consistent with the present invention;

FIG. 5 is a perspective view of a third exemplary embodiment consistent with the present invention; and

FIGS. 6-8 are block diagrams of exemplary processes consistent with the present invention.

### DETAILED DESCRIPTION OF THE INVENTION

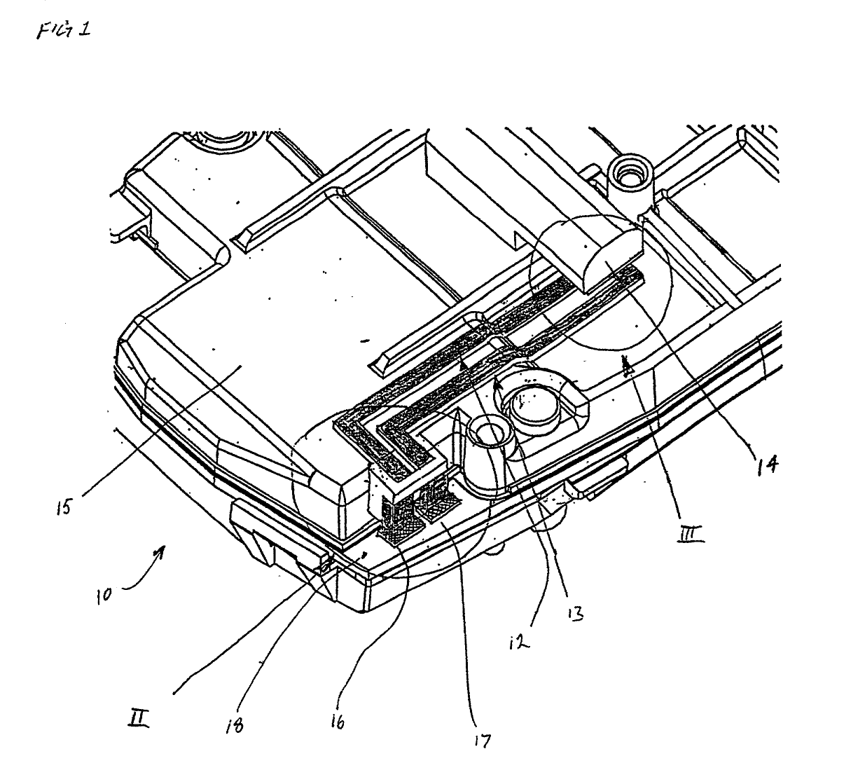

With reference to FIG. 1, a first exemplary embodiment is illustrated in the context of a mobile terminal 10 including conductive elastomer features consistent with the present invention, wherein the conductive elastomer features are configured as conductive elastomer pathways 12 and 13. As used herein, the term “mobile terminal” may include a cellular radiotelephone with or without a multi-line display; a Personal Communications System (PCS) terminal that may combine a cellular radiotelephone with data processing, facsimile and data communications capabilities; a PDA that can include a radiotelephone, pager, internet/intranet access, Web browser, organizer, calendar and/or a global positioning system (GPS) receiver; and a conventional laptop and/or palmtop receiver or other appliance that includes a radiotelephone transceiver.

As shown in FIG. 1, two conductive elastomer pathways 12 and 13 are employed to effect an electrical connection between an active element 14, such as a vibration motor, microphone, buzzer, speaker, or other active element or component, mounted on a support substrate 15, and a pair of contacts 16 and 17 on a printed circuit board (PCB) 18 of a mobile terminal 10. The PCB 18, of course, carries or supports the usual transmitter and receiver circuits, key controls, display and the like (not shown). The conductive elastomer pathways 12 and 13 may be formed directly on, and therefore follow, the contours of support substrate 15. Alternately, the conductive elastomer pathways may be disposed, e.g. on a housing component of the mobile terminal, rather than a separate substrate 15, similarly following the geometry of the housing component. If desired, the conductive elastomer pathways 12 and 13 may be configured to pass through the support structure 15, i.e. as shown in FIG. 1. The ability to precisely locate the conductive elastomer pathways 12 and 13 also enables electrical noise which may radiate from, or to, the conductive elastomer pathways 12 and 13 to be predicted and controlled or prevented.

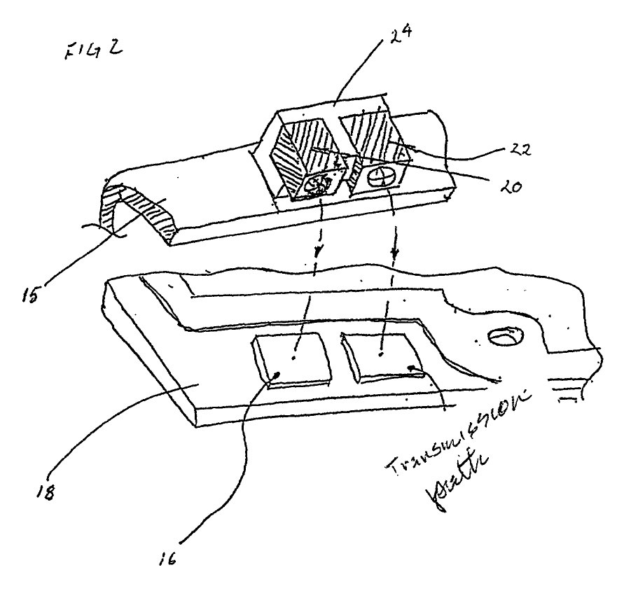

An exploded view of detail II of FIG. 1 is shown in FIG. 2, wherein there is illustrated an exemplary embodiment of a method of electrically coupling the conductive elastomer pathways 12 and 13 to another element in an electrical circuit. The electrical coupling comprises conductive elastomer contact elements 20 and 22 in physical contact with, and thereby electrically coupled to, contact pads 16 and 17 of PCB 18.

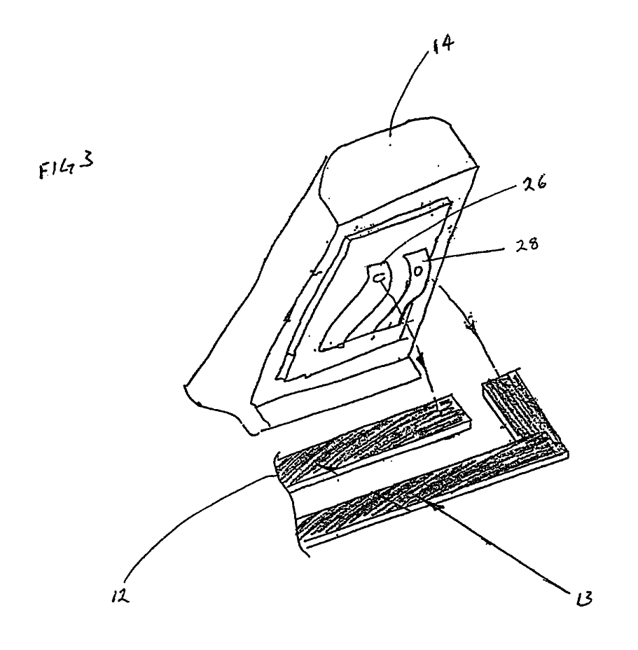

As best seen in FIGS. 2 and 3, exemplary contact elements 20 and 22 may be extensions of conductive elastomer pathways 12 and 13 respectively, wherein the contact elements 20 and 22, which may have the same or a different dimension, e.g. width, as the pathways, are configured as blocks, as illustrated, cylinders, or similar bodies, disposed on the substrate 15. Additionally, contact elements 20 and 22 may be buttressed by a retention feature 24 disposed on the substrate 15 to more securely maintain the positioning of contact elements 20 and 22. Alternately, contact elements 20 and 22 may be disposed in grooves, channels, or pockets in the substrate 15, therein securely retaining the contact elements 20 and 22.

When the substrate 15 containing the contact elements 20 and 22 is positioned relative to PCB 18 so as to provide contact between contact elements 20 and 22 and contact pads 16 and 17, the contact elements 20 and 22 elastically deform from the contact pressure. The compressive force resulting from the elastic deformation of the contact elements 20 and 22 assures a positive electrical connection between the contact elements 20 and 22 and the contact pads 16 and 17 respectively. The elastic deformation of the contact elements 20 and 22 additionally allows for a degree of movement and separation of the substrate 15, and therein the contact elements 20 and 22, relative to PCB 18, without compromising the electrical connection, provided that the movement and separation is less than the amount of elastic deformation experienced by the contact elements 20 and 22.

The amount of movement and separation of the substrate 15, having the conductive elastomer pathways 12 and 13 disposed thereon, relative to the PCB 18 may be increased by providing contact elements 20 and 22 with features that provide a greater degree of elastic deformation. Exemplary features may include slots, holes or projecting nubs that allow for resilient partial collapse of the contact elements 20 and 22 under the compressive loading experienced when the connection between the contact elements 20 and 22 and the contact pads 16 and 17 is established.

A second exemplary method of electrically coupling conductive elastomer pathways to other elements in a circuit is illustrated in FIG. 3. As shown, the vibration motor 14 comprises spring contacts 26 and 28 extending from the bottom of the vibration motor 14, wherein the spring contacts 26 and 28 provide electrical connection for the vibration motor 14. The spring contacts 26 and 28 themselves may comprise resilient metallic elements, such as copper or spring steel. The spring contacts 26 and 28 may be configured, e.g. as leaf springs, i.e., cantilevered resilient arms, or may be configured as coil spring elements, dome spring elements, or the like. Electrical connection between the vibration motor 14 and the conductive elastomer pathways 12 and 13 is achieved when the vibration motor 14 is disposed adjacent the conductive elastomer pathways 12 and 13 such that the spring contacts 26 and 28 are in physical contact with the conductive elastomer pathways 12 and 13 respectively. The resultant electrical connection is not susceptible to breakage as a result of small movements or separations of the vibration motor 14 relative to the substrate 15 on which the conductive elastomer pathways 12 and 13 are disposed. Provided the movement or separation of the vibration motor 14 is less than the resilient deformation experienced by the spring contacts 26 and 28, the spring force of the spring contacts 26 and 28 will maintain the electrical connection with the conductive elastomer pathways 12 and 13.

While the above two exemplary methods of achieving electrical connection have been illustrated and described in the context of providing connection between a PCB and a substrate and between a substrate and a vibration motor, the principles described are susceptible for providing an electrical connection between other components or portions of an electrical circuit comprising conductive elastomer features.

Furthermore, in addition to the specific exemplary electrical coupling methods described above, an electrical connection with conductive elastomer features may be accomplished in any manner that provides physical, and therein electrical, contact between the conductive elastomer feature and other components or portions of an electrical circuit. Examples of alternate connections include, but are not limited to, conductors imbedded in conductive elastomer features, conductors inserted, e.g., lanced into, conductive elastomer features, conductive elastomer features molded over a conductor, etc.

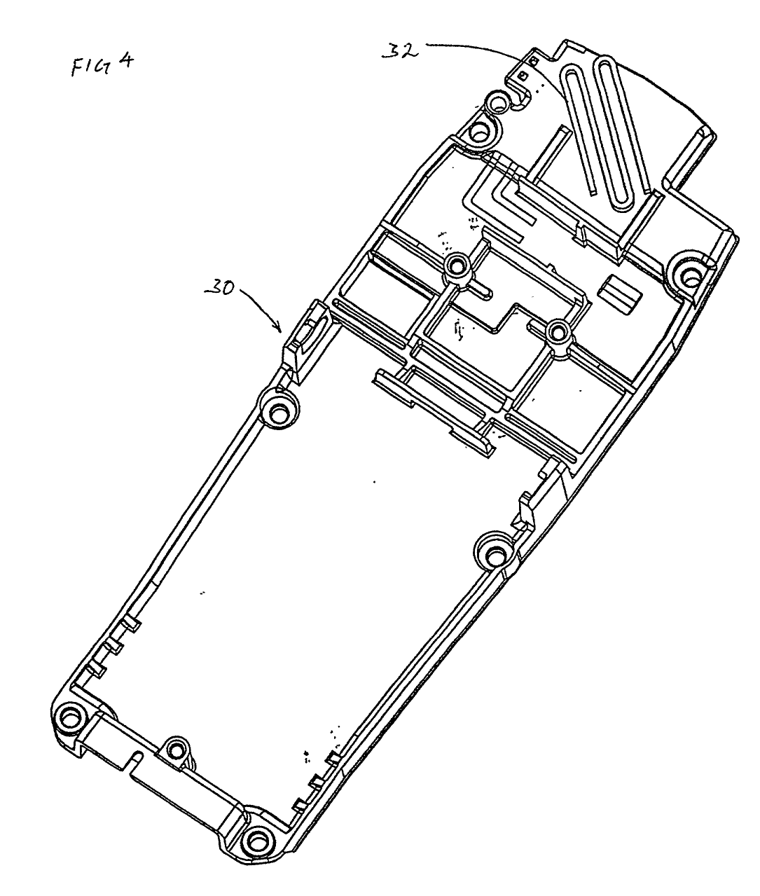

In addition to being employed as conductive pathways, in the context of mobile terminals, conductive elastomer features consistent with the present invention also may be utilized to form internal antennas for mobile terminals. In a first exemplary embodiment, illustrated in FIG. 4, an internal antenna comprising a conductive elastomer radiating element (antenna) 32 has been added to an internal structure 30 of a mobile terminal. The internal structure 30 upon which the conductive elastomer antenna 32 may be disposed may comprise a substrate, a housing component, a PCB, etc. As illustrated in FIG. 4, the conductive elastomer antenna 32 has been oriented such that it may be disposed on a relatively flat or unobstructed portion of an internal structure 30.

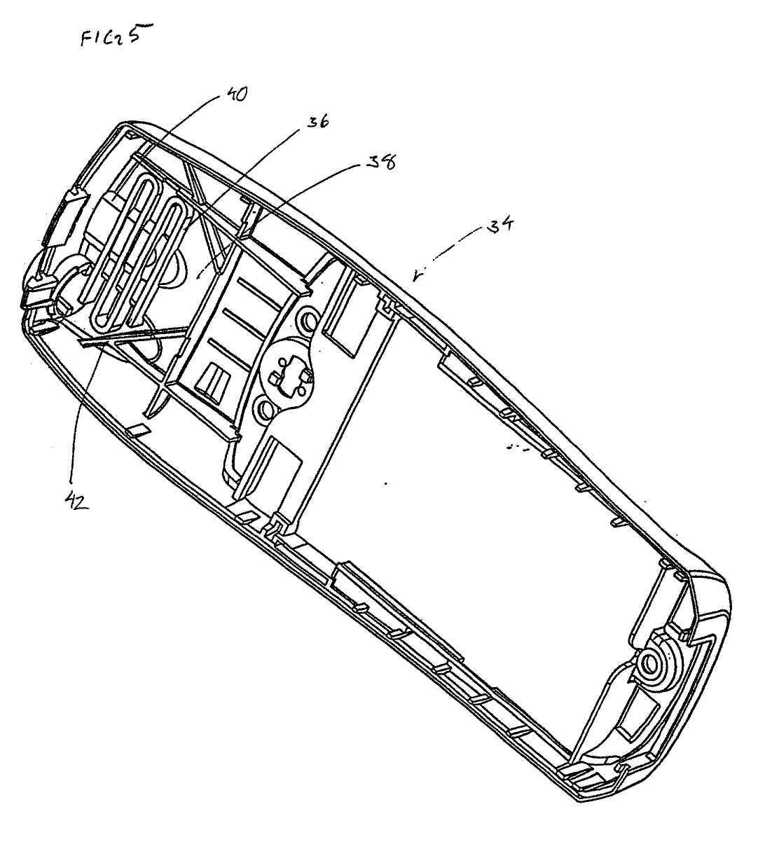

However, it is not always possible or desirable to orient or locate the radiating element on an unobstructed portion of a mobile terminal. As illustrated in FIG. 5, a second exemplary embodiment is shown wherein a conductive elastomer antenna 36 consistent with the present invention may be incorporated directly on and conforming to existing geometries on a mobile terminal internal structure 34. The exemplary internal structure 34, which may comprise, for example, a substrate or housing component, comprising an interior surface 38 having various surface features 40 and 42 disposed thereon. As shown, an antenna 36 comprising a conductive elastomer may be formed on the interior surface 38 such that the antenna 36 conforms to the geometries created by surface features 40 and 42.

Electrically coupling the antenna to the circuitry of the mobile terminal e.g. a transmission or reception circuitry may be achieved in any manner discussed hereinabove, and therefore may be achieved without requiring any additional or secondary connectors. Accordingly, the compressive force of the conductive elastomer forming the antenna advantageously may be utilized to maintain connection to circuit even under slight movement or separation of the antenna from other components coupled thereto. This variety of coupling reduces the susceptibility of the connection to cyclic or fatigue fracture, therein prolonging the life of the mobile terminal. In addition to providing a secure connection, the need for secondary connectors/connections between the antenna and circuitry of the mobile terminal may be reduced or eliminated.

It should be understood that the above discussed principles of the present invention may be applied to any cellular or wireless system utilizing air interfaces, such as GSM, TDMA, CDMA, WCDMA or Bluetooth. It should be further understood that the principles of the present invention may be utilized in hybrid systems that are combinations of two or more of the above air interfaces. Accordingly, an internal antenna consistent with the present invention may be of a pattern optimized for any such air interface. Furthermore, several antennas may be employed in a single mobile terminal, wherein each of the several antennas may be selectively configured for optimal performance over different specified bandwidths.

Conductive elastomer features consistent with the present invention comprise an elastomeric material having a conductive material dispersed in the elastomeric material. The elastomeric material may comprise a thermosetting or thermoplastic polymer material having elastomeric properties, such as silver filled silicone. The elastomeric material is loaded with a conductive material such as metal, e.g. copper or silver particles, to a sufficient level, to render the final mixture electrically conductive, or semi-conductive. The conductive material dispersed in the elastomeric material may be present in flake, rod, particulate, etc. form. Furthermore, the conductive material may comprise a composite material, for example silver plated copper or silver plated glass particles. In addition to the other detailed advantageous features, when the conductive material comprises a composite conductive material, the conductive elastomer may be selectively configured to be relatively thermally conducting or thermally insulating. According to the exemplary composite conductive materials, a conductive elastomer comprising silver plated copper will tend to be thermally conductive relative to a conductive elastomer comprising silver plated glass.

The elastic characteristics of conductive elastomer features consistent with the present invention provide a feature that is resiliently flexible in nature. The flexible nature of the feature results in a decreased risk of damage resulting from deformation, e.g. from an impact suffered by the mobile terminal, or failure resulting from fatigue or cyclic stresses. Thereby, conductive elastomer features consistent with the present invention provide reliable electric pathways and connections that may be employed without the need of secondary connections/connectors.

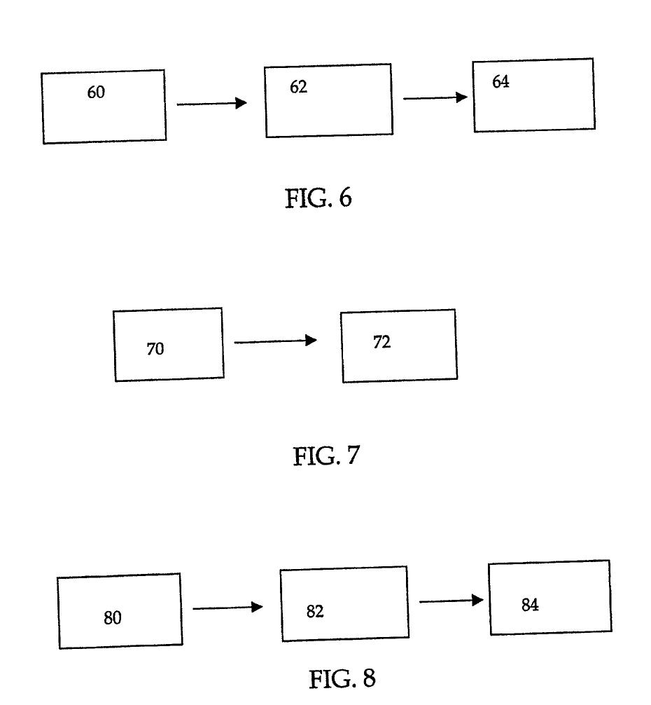

Referring to FIG. 6, conductive elastomer features consistent with the present invention may be suitably formed using processes including, but not limited to, molding, tracing and casting operations. In the context of placing conductive elastomeric features on a molded component of a mobile terminal, e.g., a substrate or a housing component, a sequential two-step molding process may be used. When produced using a sequential two-step process the substrate or housing component is injection molded in step 60 from a desired material into a first mold cavity comprising the shape of the substrate or housing component. The mold is then adjusted in step 62 to provide a second mold cavity comprising the desired shape of the conductive elastomeric feature, wherein at least a portion of the second mold cavity is defined by at least a portion of the first molded substrate or housing. Subsequently, the conductive elastomer material is injected in step 64 into the second mold cavity. Adjustment of the mold to form the second mold cavity may be achieved through slide actions in the mold, or by replacing a portion of the mold with a second mold cavity defining portion.

The conductive elastomer features also may be formed using a tracing operation. Referring in FIG. 7, consistent with a tracing operation, a bead of conductive elastomer is applied to a substrate, housing component, PCB, etc. from a nozzle in step 70, and the elastomer cured in place. The path of the bead may be controlled manually, or using an automated and/or computer controlled process. The geometry of the bead also may be controlled by varying the geometry of the nozzle and the volume of conductive elastomer dispensed. For example, a nozzle having a rectangular opening may be used to produce a feature having rectangular cross-sectional profile, while a nozzle having a circular opening may be used to produce a feature having a circular cross-sectional profile. A variety of apparatus may be used to dispense the conductive elastomer including a syringe apparatus, an extruder, or a pump.

Referring to FIG. 8, the conductive elastomer features also may be formed using a casting and/or stenciling or printing operation. According to this latter process, a stencil or mask is applied in step 80 to the substrate, housing component, or PCB and subsequently overcast and/or spray applied in step 82. Subsequent to the application of the conductive elastomer, the stencil or mask is removed in step 84, leaving a coating of conductive elastomer on the substrate, housing component, or PCB.

While the conductive elastomer features consistent with the present invention have been illustrated and described above as being generally disposed on a surface of a substrate, housing component, PCB, etc., conductive elastomer features may be at least partially integrated into the member on which the conductive elastomer feature is disposed. For example, the conductive elastomer feature may be disposed in a groove or channel formed in the substrate, housing component, PCB, etc. therein reducing the height which the conductive elastomer feature projects from the surface of the member. At least partially recessing the conductive, elastomer feature not only reduces the height, and therefore volume, of the feature projecting above the substrate, housing component, PCB, etc., but also may be used to further secure the conductive elastomer feature to the substrate, housing component, PCB, etc. On a member of sufficient thickness, a conductive elastomer feature may be formed such that it is flush with, or recessed below, the surface of the member on which it is disposed.

A conductive elastomer feature consistent with the present invention may be further integrated into a substrate, housing component, PCB, etc. by employing full thickness molding. A full thickness molded article comprises a substrate, housing component, PCB, etc. containing a full thickness cut-out formed therein, wherein the cut-out corresponds to the desired path and geometry of the conductive elastomer feature. A conductive elastomer feature may be formed in the cutout to create an integral feature. Consistent with full thickness molding the conductive elastomer feature may be configured flush with the substrate, housing component, PCB, etc. on one or both sides, or may alternately be either recessed or extend above the surface of one or both sides.

The moldability of conductive elastomer features consistent with the present invention allows connectors, conductive pathways, antennas, etc. to be formed directly on the existing geometries of substrates, housing components, PCB's, and the like. in a manner that provides nearly exact conformance with such geometries. This characteristic allows better usage of the internal surface area of mobile terminals, providing high available tolerances and a minimum of additional parts to form connections, or retain conducting features such as wiring or stamped metal internal antennas, and the like. Furthermore, when conductive elastomer features are partially, or fully, integrated with substrates, housing components, PCB's, and the like, the internal volume required for these features formed according to the present invention may be reduced, while simultaneously increasing the design and layout flexibility and capacity to optimize the pattern and routes of conductive elastomer features.

The embodiments that have been described herein, however, are but some of the several which utilize this invention and are set forth here by way of illustration but not of limitation. Other embodiments may be made without departing from the spirit and scope of the invention as set forth in the appended claims.

What is claimed is:

1. A mobile terminal comprising at least one internal antenna formed in situ on said terminal of a conductive elastomer.

2. The mobile terminal according to claim 1, wherein said conductive elastomer is disposed on an internal surface of a housing component.

3. The mobile terminal according to claim 1, wherein said conductive elastomer is disposed in a groove on an internal surface of said housing component.

4. The mobile terminal according to claim 1, wherein said conductive elastomer is disposed on a substrate housed within said mobile terminal.

5. The mobile terminal according to claim 4, wherein said conductive elastomer is disposed in a groove on said substrate.

6. The mobile terminal according to claim 1, wherein said conductive elastomer is configured for optimum transmission over a predetermined bandwidth.

7. The mobile terminal according to claim 1, wherein said conductive elastomer is configured for optimum reception over a predetermined bandwidth.

8. The mobile terminal according to claim 1, comprising a plurality of internal antennas, wherein each said internal antenna comprises a conductive elastomer.

9. The mobile terminal according to claim 8, wherein each of said plurality of internal antennas is configured for optimum reception over a predetermined bandwidth.,

10. The mobile terminal according to claim 8, wherein each of said plurality of internal antennas is configured for optimum transmission over a predetermined bandwidth.

11. The mobile terminal according to claim 1, wherein said conductive elastomer comprises an electrically conductive material dispersed in a matrix comprising an elastomeric polymer material.

12. The mobile terminal according to claim 11, wherein the electrically conductive material comprises a particulate, flake or rod material.

13. The mobile terminal according to claim 11, wherein the electrically conductive material comprises a metal or a metal plated particle.

14. The mobile terminal according to claim 11, wherein the elastomeric polymer material comprises a thermosetting or a thermoplastic elastomer.

15. A method of forming a housing component for a mobile terminal comprising an internal antenna comprising:
providing a mold defining a first mold cavity;
injecting a quantity of a first plastic material into said first mold cavity;
at least partially solidifying said first material;
adjusting said mold, therein defining a second mold cavity corresponding to a desired geometry of said internal antenna, wherein said second mold cavity is at least partially defined by said at least partially solidified first material;
injecting a quantity of a conductive elastomer into said second mold cavity.

16. A method of forming a housing component for a mobile terminal comprising an internal antenna comprising:
providing a mold defining a first mold cavity, said first mold cavity corresponding to a desired geometry of said internal antenna;
injecting a quantity of a conductive elastomer into said first mold cavity;
at least partially solidifying said conductive elastomer;
adjusting said mold, therein defining a second mold cavity, wherein said second mold cavity is at least partially defined by said at least partially solidified conductive elastomer;
injecting a quantity of a plastic material into said second mold cavity.

17. A method of forming an internal antenna for a mobile terminal comprising dispensing a conductive elastomer along a predetermined path on an internal surface of said mobile terminal, wherein said predetermined path is configured for optimal antenna performance over a predetermined bandwidth.

18. The method according to claim 17, wherein said conductive elastomer is dispensed from an extruder.

19. The method according to claim 17, wherein said conductive elastomer is dispensed from a syringe.

20. A method of forming an internal antenna for a mobile terminal comprising:
applying a mask to an internal surface of said mobile terminal, wherein said mask leaves a portion of said internal surface exposed;
applying a conductive elastomer to at least a portion of said exposed internal surface; and
removing said mask.

21. The method according to claim 20, wherein said conductive elastomer is applied uncured as a liquid.

22. The method according to claim 21, and including the step of curing said liquid to form said conductive elastomer.

23. The method according to claim 20, wherein said internal surface comprises a housing component.

24. The method according to claim 20, wherein said internal surface comprises a substrate.

25. The method according to claim 20, wherein said internal surface comprises a printed circuit board.

26. An electrical connection in a mobile terminal comprising a conductive elastomer pathway, formed in situ on said terminal by a conductive elastomer.

27. The mobile terminal according to claim 26, wherein said conductive elastomer provides a conductive pathway from a first electrical circuit to a second electrical circuit.

28. The mobile terminal according to claim 26, wherein said conductive elastomer provides at a first end a compressible contact for connection to the electrical circuit.

29. The mobile terminal according to claim 26, wherein said compressible contact is formed with at least one dimension greater than a dimensions of the conductive elastomer pathway.

30. The mobile terminal according to claim 26, wherein said conductive elastomer pathway passes through a housing for said mobile terminal.

31. The mobile terminal according to claim 26, wherein said conductive elastomer comprises an electrically conductive material dispersed in a matrix comprising an elastomeric polymer material.

32. The mobile terminal according to claim 31, wherein the electrically conductive material comprises a particulate, flake, rod material.

33. The mobile terminal according to claim 31, wherein the electrically conductive material comprises a metal or a metal plated particle.

34. The mobile terminal according to claim 26, wherein the elastomeric polymer material comprises a thermosetting or a thermoplastic elastomer.

35. The electrical connection according to claim 26, wherein said conductive elastomer pathway is disposed on an internal surface of said mobile terminal.

36. The electrical connection according to claim 35, wherein said internal surface comprises a surface of a housing component.

37. The electrical connection according to claim 35, wherein said internal surface comprises a surface of a substrate.

38. The electrical connection according to claim 35, wherein said internal surface comprises a surface of a printed circuit board.

39. The electrical connection according to claim 27, wherein first electrical circuit comprises a printed circuit board.

40. The electrical connection according to claim 27, wherein said second electrical circuit comprises a vibration motor.

41. The electrical connection according to claim 27, wherein said second electrical circuit comprises a microphone.

42. The electrical connection according to claim 27, wherein said second electrical circuit comprises a speaker.

43. The electrical connection according to claim 27, wherein said second electrical circuit comprises a buzzer.

44. The electrical connection according to claim 35, wherein said conductive elastomer pathway is disposed in a channel on said internal surface.

45. A method of forming a conductive elastomer pathway for a mobile terminal comprising:
providing a mold defining a first mold cavity, said first mold cavity corresponding to a desired geometry of said conductive elastomer pathway;
injecting a quantity of a conductive elastomer into said first mold cavity;
at least partially solidifying said conductive elastomer;
adjusting said mold, therein defining a second mold cavity, wherein said second mold cavity is at least partially defined by said at least partially solidified conductive elastomer;
injecting a quantity of a plastic material into said second mold cavity.

46. The method according to claim 45, wherein said second mold cavity corresponds to the geometry of a housing component for said mobile terminal.

47. The method according to claim 45, wherein said second mold cavity corresponds to a substrate component for said mobile terminal.

48. A method of forming a conductive elastomer pathway for a mobile terminal comprising:
providing a mold defining a first mold cavity, said first mold cavity corresponding to a desired geometry of said conductive elastomer pathway;
injecting a quantity of a plastic material into said first mold cavity;
at least partially solidifying said plastic material;
adjusting said mold, therein defining a second mold cavity, wherein said second mold cavity is at least partially defined by said at least partially solidified plastic material;
injecting a quantity of a conductive elastomer into said second mold cavity.

49. The method according to claim 48, wherein said second mold cavity corresponds to the geometry of a housing component for said mobile terminal.

50. The method according to claim 48, wherein said second mold cavity corresponds to a substrate component for said mobile terminal.

51. A method of forming a conductive elastomer pathway for a mobile terminal comprising:
applying a mask to an surface of said mobile terminal, wherein said mask leaves a portion of said internal surface exposed;
applying a conductive elastomer to at least a portion of said exposed internal surface; and
removing said mask.

52. The method according to claim 51, wherein said surface comprises a surface on a housing component.

53. The method according to claim 51, wherein said surface comprises a surface on a substrate.

54. The method according to claim 51, wherein said surface comprises a surface on a printed circuit board.

55. A mobile terminal comprising a conductive elastomer, wherein said conductive elastomer is electrically coupled to at least one circuit of said mobile terminal.

56. The mobile terminal according to claim 55, wherein said conductive elastomer is configured as an antenna, and wherein said conductive elastomer is coupled to a transmission circuit.

57. The mobile terminal according to claim 55, wherein said conductive elastomer is configured as an antenna, and wherein said conductive elastomer is coupled to a reception circuit.

58. The mobile terminal according to claim 55, wherein said conductive elastomer is a conductive pathway coupling a first portion of said at least one circuit and a second portion of said at least one circuit.
